(19) United States
(12) Patent Application Publication
(10) Pub. No.: US 2021/0391682 A1
(43) Pub. Date: Dec. 16, 2021

(54) Method and Device for Laser Radiation Modulation

(71) Applicant: National University of Science and Technology MISIS, Moscow (RU)

(72) Inventors: Vladimir Yakovlevich MOLCHANOV, Moscow (RU); Konstantin Borisovich YUSHKOV, Moscow (RU); Natalya Fedorovna NAUMENKO, Moscow (RU); Alexander Ilich CHIZHIKOV, Moscow (RU); Vasily Viktorovich GUROV, Moscow (RU); Anatoly Alekseevich PAVLYUK, Novosibirsk (RU)

(73) Assignee: Method and Device for Laser Radiation Modulation, Moscow (RU)

(21) Appl. No.: 17/059,346

(22) PCT Filed: Sep. 23, 2019
(86) PCT No.: PCT/RU19/00663

§ 371 Date: Nov. 27, 2020

(30) Foreign Application Priority Data
Mar. 6, 2019 (RU) 2019106282

(51) Int. Cl. H01S 3/117

(52) U.S. Cl. CPC H01S 3/117

(57) ABSTRACT

The proposed method and device relate to acousto-optics and laser technology and can be attributed, in particular, to acousto-optical (AO) laser resonator Q-switches, AO devices for extra-cavity control of single-mode (collimated) and multimode (uncollimated) monochromatic and non-monochromatic laser radiation, i.e, AO modulators, AO frequency shifters, and dispersion delay lines for visible and middle IR wavelengths (0.4-5.5 μm). The object of the method and device is providing a geometry of AO interaction in laser resonator Q-switches so that to optimize the preset parameters of the Q-switch in accordance with the system requirements to the laser operation mode depending on the intended use of the laser, more specifically, lower control RF power and capability of operation without additional efficiency loss with multimode or uncollimated laser radiation.

### CROSS-REFERENCE TO RELATED APPLICATIONS

This application is a U.S. national stage application of an international application PCT/RU2019/000663 filed on 23 Sep. 2019, whose disclosure is incorporated herein in its entirety by reference, which international application claims priority of a Russian Federation patent application RU2019106282 filed on 6 Mar. 2019.

### FIELD OF THE INVENTION

The present invention relates to acousto-optics and laser technology and can be attributed, in particular, to acousto-optic (AO) laser resonator Q-switches, AO devices for extra-cavity control of single-mode (collimated) and multimode (uncollimated) monochromatic and nonmonochromatic laser radiation, i.e., AO modulators, AO frequency shifters, and dispersion delay lines from visible to middle infrared (IR) wavelengths (0.4-5.5 μm).

### BACKGROUND OF THE INVENTION

AO interaction of light and ultrasound in crystals having high acoustic and photo-elastic anisotropy is considered to be one of the most promising tools for the development of acousto-optic Q-switches.

AO Q-switches or AO laser cavity dumpers are widely used for loss modulation in laser resonators aiming at the production of high-energy laser pulses. When an AO Q-switch (cavity dumper) is ON, it generates resonator loss the level of which is higher than the gain per pass. The laser is then not generating. The loss level is determined by the Q-switch efficiency which should be a priori higher than the gain per pass at the given excitation level. The typical required diffraction efficiency (the loss introduced by the Q-switch) of advanced solid state pulse 1 μm wavelength range lasers is 75%. When an AO Q-switch is OFF the resonator loss for the time determined by the acoustic front pass time through the laser beam aperture in the Q-switch is reduced to the static level. As a result, giant pulse generation develops in the laser.

The operation principle of the AO Q-switches is as follows. An acoustic wave is excited by a piezotransducer attached using one of the known methods to the acoustic surface of a crystal or an amorphous transparent medium. The acoustic wave propagates in the transparent medium and produces local mechanical deformation regions of the medium material. Due to the photo-elastic effect, the mechanical stress generates local inhomogeneities in the dielectric permeability and hence in the refraction index of the medium. Periodical layers with different refraction indices are formed in the medium. These layers move at the speed of sound. Light propagation through the medium with a periodically spatially structured refraction index produces diffraction. As a rule, AO Q-switches operate in Bragg diffraction regime. Bragg diffraction takes place if a diffraction spectrum consists of two maxima: the straight transmitted zero-order one and the first-order one deflected at the double Bragg angle. The −1 order and high-order diffraction maxima have negligibly low intensities. The intensity of the first (the so-called Bragg) maximum is the highest if the light is incident at the Bragg angle relative to the acoustic wavefront.

The most widely used material for Q-switches is fused silica and more rarely crystal quartz. These materials have high laser-induced damage threshold but low AO figure of merit (efficiency).

It is known from the state of the art (U.S. Pat. No. 6,563,844 B1, published 13 May 2003) that a typical quartz AO Q-switch for 1.06 μm wavelength produces a reference loss level of 75% in the resonator of a typical Nd:YAG laser at a high-frequency (HF) control power of 30 W. The standard technical solution is either water cooling or thermoelectric cooling with Peltier elements of the laser cavity dumper. Q-switch operation practice suggests that forced cooling is efficient until a HF power of 50-60 W, whereas at higher power the Q-switch overheating cannot be countered.

New high power middle IR lasers (2-5.5 μm) have been developed in recent years which use Q-switches or pump lasers with the Q-switches. Examples are pulse lasers based on Er³⁺ ion activated crystals (3 μm wavelength) or Ho³⁺ ion activated crystals (2 μm wavelength) operating in Q-switching mode; 3-5 semiconductor lasers doped with bivalent transition metal ions Cr²⁺ and Fe²⁺. These lasers are widely used in spectroscopy, remote probing, medicine etc. Resonator Q-switching in these lasers is provided with mechanical shutters, polygonal mirrors, total internal reflection shutters etc. Quartz AO Q-switches are not used in middle IR lasers (2-5.5 μm) because the efficiency (loss level) of the acousto-optic Q-switches is in a linear approximation inversely proportional to squared wavelength and therefore achieving the standard 75% loss level with a typical quartz Q-switch for a Er³⁺:YAG laser (2.94 μm) would theoretically require a HF power of 270 W that is practically unfeasible.

All crystals are known to have anisotropy of acoustic properties (K. N. Baranskii, Physical Acoustics of Crystals, Moscow, MSU, 1991) and photo-elastic properties (J. F. Nye, Physical Properties of Crystals: Their Representation by Tensors and Matrices).

The anisotropy of acoustic properties manifests itself in that, in a general case, three elastic waves may propagate in a single crystal in an arbitrary direction at different velocities and polarizations, and the directions of the wave vector K and the energy flow vector S of each of the waves are different. If the angle between the wave vector K and the energy flow vector S is ψ the group velocity V_{g} for this direction of the vector K is related with the phase velocity Vₚ for the same direction through the relationship V_{g}=Vₚ/cos ψ. Thus the group wave velocity in an anisotropic medium is never smaller than the phase velocity of the wave. In a particular case there may be directions in a crystal along which the directions of the wave vector K and the energy flow vector S coincide. Then ψ=0 and the group velocity is equal to the phase velocity. These directions are the crystal symmetry axes, the maxima and the minima of the phase velocity Vₚ.

The anisotropy of photo-elastic properties shows itself in that the effective photo-elastic constant of acousto-optic interaction depends on the propagation directions and polarizations of the optical and acoustic waves in a crystal. Thus the propagation direction of the acoustic wave for a given laser beam propagation direction determines the AO figure of merit M₂.

Potassium rare-earth tungstate crystals KRE(WO₄)₂ where RE=Y, Yb, Gd and Lu are a novel and yet insufficiently studied material for photonic devices. KRE(WO₄)₂ group crystals have the 2/m monoclinic symmetry. Their laser induced damage threshold is several times higher than that of the acousto-optic material paratellurite. The crystals have two optical axes, with one of the refraction index ellipsoid symmetry axes Nₚ corresponding to the minimum eigenvalue of the dielectric permeability tensor being coincident with the [010] crystallographic axis, and the other two refraction index ellipsoid symmetry axes, Nₘ and N_{g}, corresponding to the maximum eigenvalue of the dielectric permeability tensor lying in the (010) crystallographic plane and forming a Cartesian coordinate system. Some of the elastic and photo-elastic properties of KRE(WO₄)₂ were studied earlier (M. M. Mazur, D. Yu. Velikovskiy, L. I. Mazur, A. A. Pavluk, V. E. Pozhar, and V. I. Pustovoit, “Elastic and photo-elastic characteristics of laser crystals potassium rare-earth tungstates KRE(WO₄)₂, where RE=Y, Yb, Gd and Lu”, Ultrasonics 54 (2014) 1311-1317). The data obtained in that work show that the AO figure of merit of KRE(WO₄)₂ group crystals in some cut directions may be several times higher than the AO figure of merit of fused silica, these crystals thus being quite promising for middle IR wavelength AO device applications. KRE(WO₄)₂ group crystals have strong anisotropy of elastic, photo-elastic and optical properties.

The closest counterpart (prototype) of the method claimed herein is the method of laser radiation modulation by acoustic wave when the directions of the wave vector and the energy flow vector (Umov-Poynting vector) are coincident. The method was described by R. V. Johnson “Design of Acousto-Optic Modulators”, Ch. 3 in “Design and Fabrication of Acousto-Optic Devices”, A. P. Goutzoulis and D. R. Pape Eds., New York: Marcel Dekker, 1994. For this method the width of the acoustic column in a crystal is equal to the width of the piezotransducer. This modulation method can be implemented in isotropic materials e.g. glasses and fused silica and in single crystals when an acoustic wave propagates along a symmetry axis e.g. in crystalline quartz, paratellurite and lead molybdate. A disadvantage of said prototype is a high power density of the electric and acoustic fields at the piezotransducer. AO Q-switches are usually powered by HF 20-40 W and are operated with forced external cooling. The high power density causes intense local heat release in the AO Q-switch piezotransducer. Strong local heating of the piezoelectric plate may destroy the plate or the AO crystal prism to which it is connected because of the difference and anisotropy of the thermal expansion coefficients of the materials of the piezoelectric plate and the AO crystal.

The closest counterpart (prototype) of the device claimed herein is the AO Q-switch (RU Patent 2476916 C1, published 30 Nov. 2011). The Q-switch is based on KRE(WO₄)₂ group crystals and operates in non-collinear diffraction regime with a quasi-longitudinal acoustic wave, with the ultrasound propagation direction being parallel to the refraction index ellipsoid symmetry axis N_{g}. A disadvantage of said prototype is a relatively low AO figure of merit M₂ and hence high control HF power. Another disadvantage of said prototype is a low diffraction efficiency when the device is operated with multimode or uncollimated lasers. The hinder to the achievement of the required technical result for the prototype is that the Q-switch is operated with a quasi-longitudinal (QL) acoustic wave and the respective AO interaction geometry.

### SUMMARY OF THE INVENTION

The technical result of the first object of the present invention is the purposeful use of the properties relating to the acoustic anisotropy of the crystal, more specifically, increasing the area of the piezotransducer by propagating the acoustic beam in the crystal along a crystallographic direction other than the crystal's symmetry axis or a local extremum of the acoustic wave velocity. The width of the acoustic column in the crystal is always smaller than the width of the piezotransducer, and the efficiency of AO interaction is higher; this allows one to increase the area of the piezotransducer and therefore reduce the HF electric power density at the piezotransducer and hence provide for its less intense heating.

Additionally, if the directions of the wave vector K and the energy flow vector S of the acoustic wave are different, the operation of the AO Q-switch becomes faster because it depends on the time required for the acoustic pulse wavefront to cross the laser beam. In the case considered, this time decreases because the acoustic anisotropy makes it dependent on the group velocity V_{g} rather than by the phase velocity Vₚ, i.e., on the greater of the two values.

Said technical result of the first object of the present invention is achieved as follows. Laser radiation modulation method comprising excitation in a KRE(WO₄)₂ group single crystal of a amplitude-modulated traveling quasi-shear acoustic wave with the polarization orthogonal to the Nₚ axis and propagating in the NₘN_{g} plane of the crystal, wherein the laser beam has the polarization of the proper wave in the crystal and propagates at Bragg angles from 0.15 to 8 arc deg relative to the acoustic wavefront and the acoustic wave frequency in the AO crystal meets the phase matching condition for laser beam diffraction.

The technical result of the second object of the present invention is the purposeful provision of such geometry of AO interaction in the laser resonator Q-switch that to achieve a lower control HF power and the capability of operation without additional efficiency loss with multimode or uncollimated laser radiation.

Said technical result of the second object of the present invention is achieved as follows. The acousto-optic Q-switch comprises AO prism made from a KRE(WO₄)₂ group single crystal the acoustic surface of which is parallel to the Nₚ axis of the crystal and is at an angle of 0 to −40 arc deg to the Nₘ axis and the opposite surface of which is at an arbitrary angle to the acoustic surface, an acoustic absorber attached to said opposite surface, an input optical surface with an antireflection coating, an output optical surface with an antireflection coating, and a shear piezotransducer made from a lithium niobate plate with a thickness of 15 to 200 μm attached to said acoustic surface.

Furthermore, said KRE(WO₄)₂ group single crystal is a potassium gadolinium tungstate KGd(WO₄)₂ crystal or a potassium yttrium tungstate KY(WO₄)₂ crystal or a potassium lutetium tungstate KLu(WO₄)₂ crystal or a potassium ytterbium tungstate KYb(WO₄)₂ crystal.

In a specific embodiment said piezotransducer is attached to said AO prism using glue attachment or using direct dielectric bonding or using cold vacuum bonding with the formation of binary alloys or using atomic diffusion bonding of similar alloys.

### BRIEF DESCRIPTION OF THE DRAWINGS

The invention is illustrated with the following drawings.

FIG. 1. Polar projection of AO figure of merit of non-collinear geometry of isotropic AO diffraction for quasi-shear (QS) acoustic wave propagating in the NₘN_{g} plane of potassium yttrium tungstate.

FIG. 2. AO figure of merit of isotropic AO diffraction for quasi-longitudinal (QL) and quasi-shear (QS) acoustic waves propagating in the NₘN_{g} plane of potassium yttrium tungstate.

FIG. 3. Vector diagram of diffraction in AO Q-switch.

FIG. 4. Phase velocity of ultrasound and deflection angle in the NₘN_{g} plane of potassium yttrium tungstate.

FIG. 5. AO prism orientation relative to crystal symmetry axes.

FIG. 6. AO Q-switch design.

FIG. 7. Photo of experimental KY(WO₄)₂ crystal AO Q-switch.

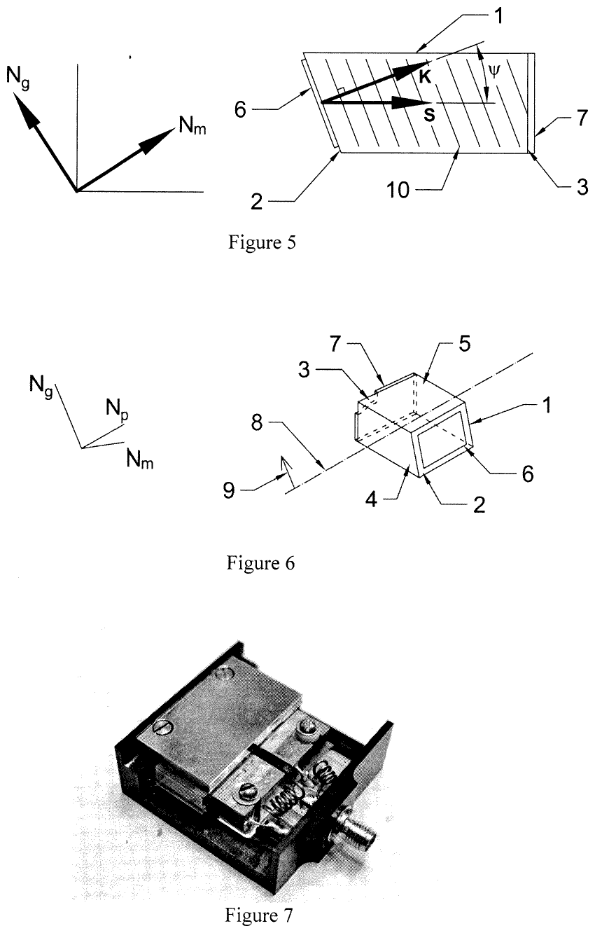

The notations in FIGS. 5 and 6 are as follows: (1) potassium yttrium tungstate AO prism; (2) crystal acoustic surface; (3) crystal surface opposite to acoustic one; (4) crystal input optical surface; (5) crystal output optical surface; (6) shear piezotransducer; (7) acoustic absorber; (8) input laser beam; (9) input beam polarization vector; and (10) quasi-shear elastic wave in crystal.

The technical result of the first object of the invention is achievable because an amplitude-modulated traveling acoustic wave is generated in a single crystal with large acoustic anisotropy in a direction other than the crystal's symmetry axis. As a result the directions of the phase and group acoustic wave velocities differ and the acoustic beam cross-section becomes smaller than the area of the piezotransducer, therefore the AO Q-switch operation becomes faster. The laser beam has the polarization of the proper wave in the crystal and propagates at the Bragg angle, and the acoustic wave frequency meets the phase matching condition.

The single crystal belongs to the KRE(WO₄)₂ group, the acoustic wave is a quasi-shear one, propagates in the NₘN_{g} plane of the crystal and is polarized orthogonally to the Nₚ axis of the crystal, and the laser beam direction which is polarized parallel to the N_{g} axis of the crystal is at a Bragg angle of 0.15 to 8 arc deg relative to the acoustic wavefront.

The technical result of the second object of the invention is achievable because the Q-switch is operated with a quasi-shear acoustic wave propagating along the crystal's symmetry axis. Here Nₘ and N_{g} form a Cartesian coordinate system related to the dielectric axes of the crystal. The second order symmetry axis Nₚ is directed perpendicular to the drawing plane. The AO figure of merit M₂ of the crystal for the quasi-shear acoustic wave is shown by a solid line for two proper polarizations of light wave in the crystal (solid line: polarization along Nₘ, dashed line: polarization along N_{g}). The elastic, photo-elastic and optical constants of the KRE(WO₄)₂ group crystals are close. Hereinafter the calculations are performed for yttrium tungstate KY(WO₄)₂.

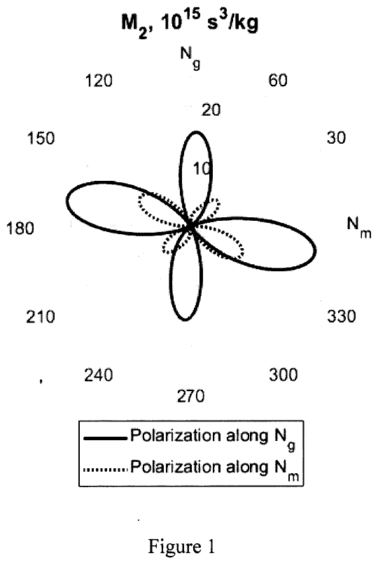

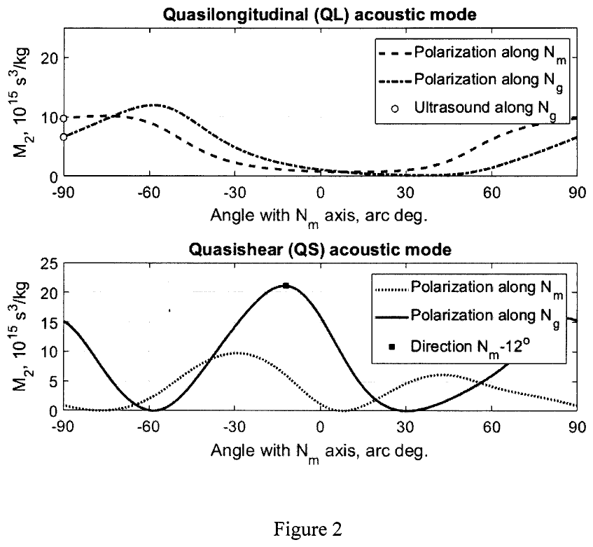

It can be seen from FIGS. 1 and 2 that if the light is polarized along the N_{g} axis the AO figure of merit M₂ of the crystal is as high as 22×10⁻¹⁵ s³/kg at a quasi-shear acoustic wave propagation angle of −12 arc deg relative to the Nₘ axis which is only 35% smaller than the AO figure of merit M₂ for classic orientation AO Q-switch for fast longitudinal wave in paratellurite which has been used in industrial AO Q-switches for more than 50 years. In the 0 to 28 arc deg range the AO figure of merit is above 15×10⁻¹⁵ s³/kg, i.e., it is by more than 10 times higher than the maximum AO figure of merit of fused silica. The AO figure of merit M₂ of the prototype for quasi-longitudinal ultrasonic wave along the N_{g} axis is within 10×10⁻¹⁵ s³/kg. Thus, the present invention eliminates the first disadvantage of the prototype, i.e., the relatively high control HF power.

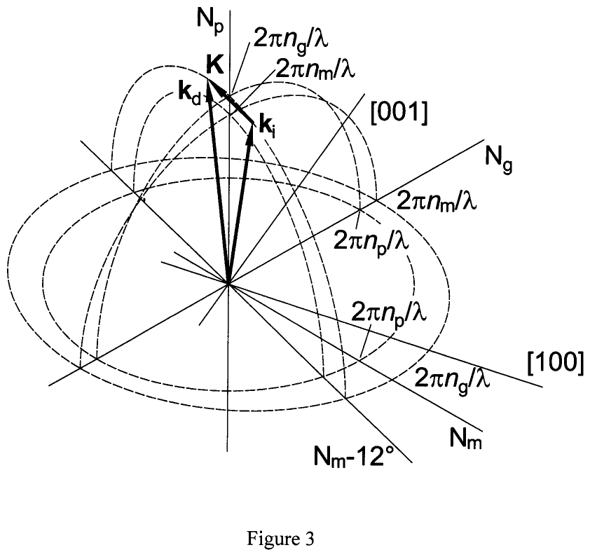

FIG. 3 schematically shows the geometry of AO interaction in an isometric projection as per the present invention. The birefringence and the Bragg angle are shown oversized for demonstrativeness. Dashed lines show the sections of the light wave normal surface by the NₘN_{g} and NₚN_{g} planes and the diffraction plane which is parallel to the Nₚ axis and is at a −12 arc deg angle to the Nₘ axis.

A specific essential feature of the invention is that the piezotransducer plate made from a lithium niobate crystal is attached to the acoustic surface of the AO prism made from a KRE(WO₄)₂ crystal by a unique vacuum nanotechnology with the formation of binary alloys (RU Patent 2646517C1 05.03.2018) which reduces conversion losses for HF electric power conversion to acoustic power as compared with other attachment technologies.

The other disadvantage of the prototype which hinders the operation of the AO Q-swtich with multimode laser radiation is the reduced AO Q-switch diffraction efficiency for operation with divergent radiation the divergence of which is comparable with or exceeds the diffraction divergence of the acoustic wave generated by the piezotransducer.

The physical origin of this phenomenon is that in this case the high-frequency components of the light wave angular spectrum do not meet the Bragg phase matching condition with the angular spectrum of the acoustic wave and therefore their participation in diffraction is little if any. The diffraction divergence of the acoustic wave generated by the homogeneous piezotransducer is described by the formula v/Lf, where v is the velocity of the acoustic wave, L is the length of the piezotransducer and f is the frequency.

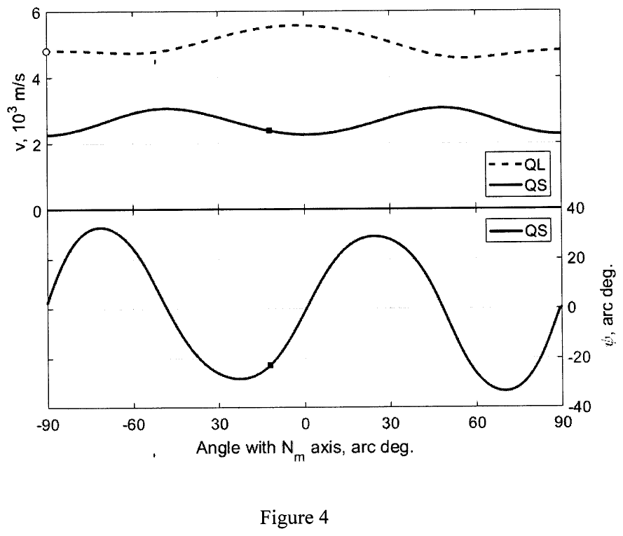

The technical result of the invention is particularly illustrated on FIG. 4, and achieved because the velocity of the quasi-shear acoustic wave corresponding to the maximum AO figure of merit M₂ is reached at an angle of −12 arc deg and is equal to 2.4×10³ m/s; the velocity of the quasi-longitudinal acoustic wave of the prototype at −90 arc deg is 4.8×10³ m/s. Thus, other conditions being the same, the acoustic angular spectrum of this invention is 2 times broader compared to that of the prototype. Therefore, other conditions being the same, the AO Q-switch provided herein unlike the prototype can be operated without compromise in efficiency with multimode or uncolimated laser radiation the divergence of which is 2 times greater than the divergence of collimated radiation.

The acoustic anisotropy of the crystal shows itself, in particular, in that the angle ψ between the direction of the wave vector K and the group velocity S of the quasi-shear acoustic wave in the NₘN_{g} crystallographic plane of the potassium yttrium tungstate crystal polarized orthogonally to the Nₚ axis may exceed 30 arc deg by absolute value, as shown in FIG. 4. In particular, in the −12 arc deg direction relative to the Nₘ axis in which the AO figure of merit M₂ is the maximum for the light wave polarized parallel to the N_{g} axis, the angle ψ is approximately −23 arc deg.

The KRE(WO₄)₂ group crystals have high laser-induced damage threshold and sufficiently high AO effect which makes them the most promising material for acousto-optic Q-switches, dispersion delay lines and AO frequency shifters for visible and middle IR wavelengths. For example, the minimum laser damage threshold of KGd(WO₄)₂ crystals is 50 GW/cm² for 20 ns pulses at 1064 nm (I. V. Mochalov, “Laser and nonlinear properties of the potassium gadolinium tungstate laser crystal KGd(WO₄)₂:Nd³⁺-(KGW:Nd)”, Optical Engineering 36 (1997) 1660-1669). KRE(WO₄)₂ group materials have high optical and acoustic anisotropy which depends largely on the crystal orientation relative to the crystallographic axes.

### PREFERRED EMBODIMENTS OF THE INVENTION

The present invention is implemented as follows. The acousto-optic Q-switch comprises an AO prism 1 made from a KRE(WO₄)₂ group single crystal and having an acoustic surface 2 which is parallel to the Nₚ axis of the AO prism 1 crystal, its normal being at an angle of 0 to −30 arc deg relative to the Nₘ axis, an opposite surface 3, an input optical surface 4 which is orthogonal to the Nₚ axis, an output optical surface 5 which is orthogonal to the Nₚ axis, a piezotransducer 6 attached to said acoustic surface 2, and an acoustic absorber 7 attached to said opposite surface 3. Said piezotransducer 6 made from a lithium niobate plate with a thickness of 15 to 200 μm excites a quasi-shear acoustic wave 10 in said AO prism 1. Said acoustic absorber 7 is attached to the surface 6 of said AO prism 1 which is at an arbitrary angle to said acoustic surface 2 thus providing a traveling acoustic wave in said AO prism 1. The input laser beam 8 has the polarization 9 parallel to the N_{g} axis of the crystal and propagates at a Bragg angle of 0.5 to 1.5 arc deg relative to the normal in the diffraction plane formed by the Nₚ axis of the crystal and the normal to said acoustic surface 2 of said AO prism 1.

For reducing the control HF power said piezotransducer can be attached using the unique vacuum technology with the formation of binary alloys to said acoustic surface 3 of said AO prism 1. Said piezotransducer alternatively can be attached to said acoustic surface 3 of said AO prism 1 using glue attachment or using atomic diffusion bonding of similar metals (T. Shimatsu and M. Uomoto, “Atomic diffusion bonding of wafers with thin nanocrystalline metal films”, J. Vac. Sci. Technol. B 28 (2010) 706-704) or using direct bonding (K. Eda, K. Onishi, H. Sato, Y. Taguchi, and M. Tomita, “Direct Bonding of Piezoelectric Materials and Its Applications”, Proc. 2000 IEEE Ultrasonics Symposium (2000) 299-309), providing for an acoustic contact between the bonded surfaces.

Said acoustic wave absorber 7 can be fabricated using the unique vacuum technology on the basis of a binary alloy with indium excess for efficient absorption of the traveling shear acoustic wave.

The present invention was tested experimentally. The instant inventors fabricated an experimental AO Q-switch from a potassium yttrium tungstate crystal for operation with horizontally polarized input laser radiation, and confirmed our calculation data. FIG. 7 shows a photo of the fabricated experimental AO Q-switch. The active aperture of the AO Q-switch was 2.0 mm, the piezotransducer length was 14.0 mm, and the working frequency of the ultrasound was 100 MHz. The measurements were carried out at 532 nm. The maximum diffraction efficiency was 96% at a control power of 15 W. The main parameters of the AO Q-switch if recalculated for a 1064 nm wavelength were as follows: efficiency in excess of 95% at a control power of 2.0 W and a piezotransducer length of 40 mm

What is claimed is a:

1. Laser radiation modulation method comprising excitation in a KRE(WO₄)₂ group single crystal of a amplitude-modulated traveling quasi-shear acoustic wave with the polarization orthogonal to the Nₚ axis and propagating in the NₘN_{g} plane of the crystal, wherein the laser beam has the polarization of the eigenwave in the crystal and propagates at Bragg angles from 0.15 to 8 arc deg relative to the acoustic wavefront and the acoustic wave frequency in the acousto-optic prism meets the phase matching condition for laser beam diffraction.

2. Acousto-optic Q-switch comprising an acousto-optic prism made from a KRE(WO₄)₂ group single crystal the acoustic surface of which is parallel to the Nₚ axis of the crystal and is at an angle of 0 to −40 arc deg to the Nₘ axis, an opposite surface which is at an arbitrary angle to said acoustic surface, an acoustic absorber attached to said opposite surface, an input optical surface with an antireflection coating, an output optical surface with an antireflection coating, and a shear piezotransducer made from a lithium niobate plate with a thickness of 15 to 200 μm attached to said acoustic surface.

3. Acousto-optic Q-switch of claim 2 wherein said KRE(WO₄)₂ group single crystal is a potassium gadolinium tungstate KGd(WO₄)₂ crystal or a potassium yttrium tungstate KY(WO₄)₂ crystal or a potassium lutetium tungstate KLu(WO₄)₂ crystal or a potassium ytterbium tungstate KYb(WO₄)₂ crystal.

4. Acousto-optic Q-switch of claim 2 wherein said piezotransducer is attached to said acousto-optic prism using glue attachment or using direct dielectric bonding or using vacuum diffusion bonding with the formation of binary alloys or using atomic diffusion bonding of similar alloys.
